(19) United States
(12) Patent Application Publication
(10) Pub. No.: US 2023/0198365 A1
(43) Pub. Date: Jun. 22, 2023

(54) VIBRATION MOTOR AND ELECTRONIC DEVICE

(71) Applicant: Nidec Corporation, Kyoto (JP)

(72) Inventors: Atsunori HIRATA, Kyoto (JP); Tomohiro KOBAYASHI, Kyoto (JP)

(21) Appl. No.: 18/083,006

(22) Filed: Dec. 16, 2022

(30) Foreign Application Priority Data
Dec. 21, 2021 (JP) 2021-206594

(51) Int. Cl. H02K 33/16; H02K 33/02; H02K 5/04

(52) U.S. Cl. CPC H02K 33/16; H02K 33/02; H02K 5/04

(57) ABSTRACT

A vibration motor includes a stator, a vibrator capable of vibrating in a left-right direction, and an elastic portion that connects the vibrator and the stator. The vibrator includes a mass body including a groove recessed in an up-down direction, and a magnet fixed to the mass body inside the groove when viewed in the up-down direction. The stator includes a coil located inside the groove and opposing the magnet in the up-down direction, and a protector covering at least a portion of two ends of the coil in the left-right direction. The groove includes a first opposing surface. The protector includes a second opposing surface. The first opposing surface and the second opposing surface oppose each other in the left-right direction.

### CROSS-REFERENCE TO RELATED APPLICATIONS

The present application claims priority under 35 U.S.C. § 119 to Japanese Patent Application No. 2021-206594, filed on Dec. 21, 2021, the entire contents of which are hereby incorporated herein by reference.

### 1. Field of the Invention

The present disclosure relates to a vibration motor and an electronic device.

### 2. Background

Various electronic devices such as a smartphone and other portable devices have conventionally included a vibration motor as a vibration generator. The vibration motor is used for a function of notifying a user of an incoming call, an alarm, and the like, or a function of haptic feedback in a human interface, for example.

In general, a vibration motor includes a stator, an elastic portion, and a vibrator. The stator includes a housing and a coil. The vibrator includes a magnet. The vibrator and the housing are connected by an elastic portion. When the coil is energized to generate a magnetic field, the vibrator vibrates.

The vibration motor has been conventionally configured such that the vibrator is prevented from being displaced by providing a cushioning member in the elastic portion sometimes to allow parts of the elastic portion to be indirectly brought into contact with each other with the cushioning member interposed therebetween even when the vibrator excessively moves, thereby preventing the vibrator from coming into contact with a coil. Unfortunately, even indirect contact between the parts of the elastic portion may be undesirable depending on a shape of the elastic portion.

### SUMMARY

An example embodiment of a vibration motor of the present disclosure includes a stator, a vibrator capable of vibrating in a left-right direction, and an elastic portion that connects the vibrator and the stator. The vibrator includes a mass body including a groove recessed in an up-down direction, and a magnet fixed to the mass body inside the groove when viewed in the up-down direction. The stator includes a coil located inside the groove and opposing the magnet in the up-down direction, and a protector covering at least a portion of two ends of the coil in the left-right direction. The groove includes a first opposing surface. The protector includes a second opposing surface. The first opposing surface and the second opposing surface oppose each other in the left-right direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vibration motor according to an example embodiment of the present disclosure.

FIG. 2 is a perspective view of a vibration motor according to an example embodiment of the present disclosure in a state where a lid is removed.

FIG. 3 is a sectional view of the vibration motor in the state of FIG. 2 taken along a section orthogonal to a fore-and-aft direction.

FIG. 4 is a perspective view of an assembly according to an example embodiment of the present disclosure including a coil and a protection portion.

FIG. 5 is a plan view illustrating an internal configuration of a vibration motor according to an example embodiment of the present disclosure as viewed from above.

FIG. 6 is a partial sectional view of a vibration motor according to an example embodiment of the present disclosure taken along a section orthogonal to the fore-and-aft direction.

FIG. 7 is an enlarged view of a first opposing surface and a second opposing surface in the configuration illustrated in FIG. 6.

FIG. 8 is a schematic diagram illustrating an example of an electronic device according to an example embodiment of the present disclosure.

### DETAILED DESCRIPTION

Hereinafter, example embodiments of the present disclosure will be described with reference to the drawings. The drawings each show a left-right direction that is defined as an X-axis direction, and that has a left side defined as X1, and a right side defined as X2. The drawings each also show a fore-and-aft direction that is defined as a Y-axis direction, and that has a front side defined as Y1, and a rear side defined as Y2. The drawings each further show an up-down direction that is defined as a Z-axis direction, that has an upper side defined as Z1, and a lower side defined as Z2. The left-right direction, the fore-and-aft direction, and the up-down direction are orthogonal to each other. Each of the above directions does not limit a direction when the vibration motor is incorporated in a device.

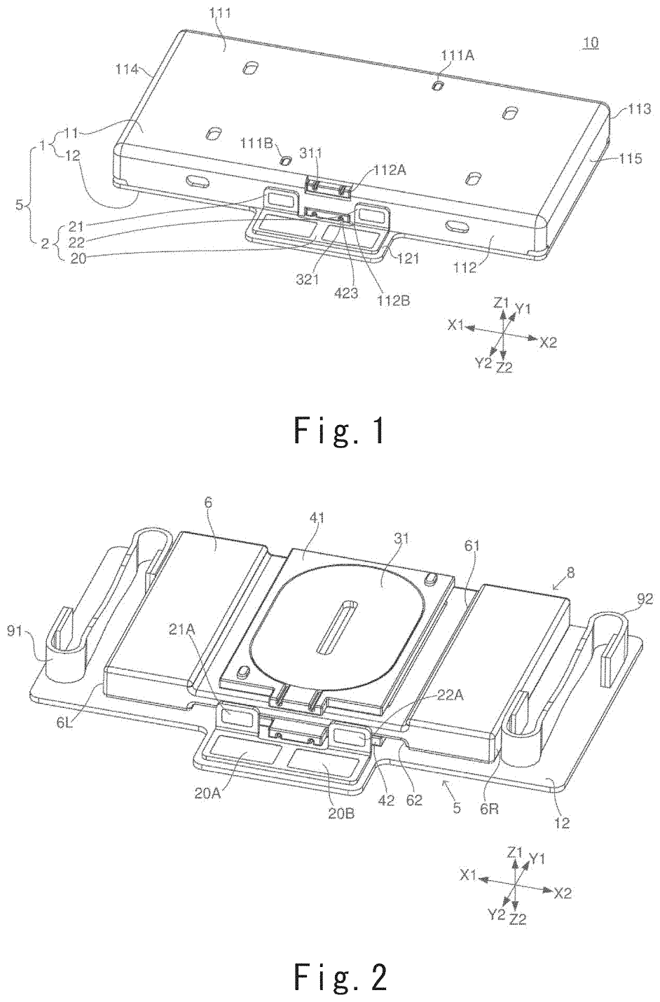

FIG. 1 is a perspective view of a vibration motor 10 according to an example embodiment of the present disclosure. FIG.

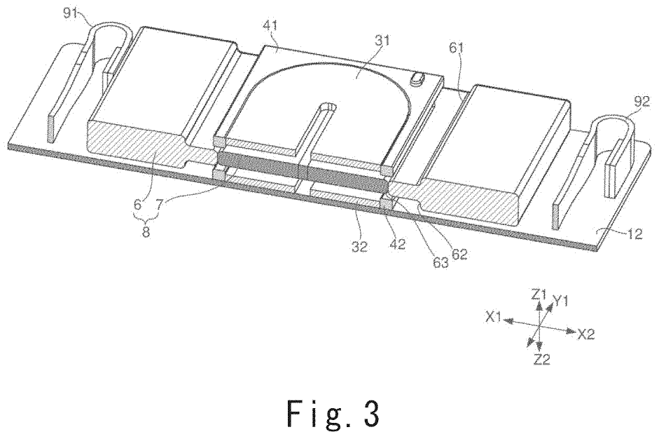

2 is a perspective view of the vibration motor 10 in a state where a lid 11 is removed. The lid 11 is included in a housing 1 as described later. That is, FIG. 2 illustrates an internal configuration of the vibration motor 10. FIG. 3 is a sectional view of the vibration motor 10 in the state of FIG. 2 taken along a section orthogonal to the fore-and-aft direction.

The vibration motor 10 is a so-called transverse linear vibration motor capable of generating vibration in the left-right direction. The vibration motor 10 includes a stator 5, a vibrator 8, and elastic portions 91 and 92.

The stator 5 includes the housing 1, a board 2, coils 31 and 32, and protection portions 41 and 42.

The housing 1 is made of stainless steel, for example, and includes the lid 11 and a base plate 12. The housing 1 is formed by attaching the lid 11 to the base plate 12 from above. The lid 11 has a rectangular body shape opened downward, and includes a top surface part 111, a front surface part 112, a rear surface part 113, a left surface part 114, and a right surface part 115. The front surface part 112, the rear surface part 113, the left surface part 114, and the right surface part 115 extend downward from respective sides of the top surface part 111. The base plate 12 is a plate-like member expanding in the left-right direction and the fore-and-aft direction. The lid 11 and the base plate 12 define a space in which the vibrator 8, the coils 31 and 32, the protection portions 41 and 42, and the elastic portions 91 and 92 are accommodated. That is, the stator 5 includes the housing 1 configured to cover the vibrator 8, the elastic portions 91 and 92, the coils 31 and 32, and the protection portions 41 and 42.

The board 2 is a flexible printed circuit (FPC), and includes a base 20 and bent portions 21 and 22 bent from the base 20. The base plate 12 has a protruding piece 121 protruding forward from its front edge. The base 20 is disposed on the protruding piece 121. The bent portions 21 and 22 are disposed along the front surface part 112 of the lid 11. The board 2 is electrically connected to the coils 31 and 32. The board 2 is provided to supply an electric current to the coils 31 and 32.

The coils 31 and 32 are disposed facing each other in the up-down direction. The coil 31 is disposed above the coil 32. That is, the vibration motor 10 has two coils. The coils 31 and 32 are each formed by winding a conductive wire around an axis along the up-down direction. When an electric current is supplied to the coils 31 and 32, lines of magnetic force are generated.

The coil 31 is accommodated in the protection portion 41. The coil 32 is accommodated in the protection portion 42. That is, the protection portions 41 and 42 face each other in the up-down direction. The protection portions 41 and 42 are made of resin, for example. The coil 31 and the protection portion 41 are disposed on a lower surface of the top surface part 111 of the lid 11. The coil 32 and the protection portion 42 are disposed on an upper surface of the base plate 12. The protection portions 41 and 42 protect the coil 31 from a contact with a mass body 6 described later. Details of the coils 31 and 32 and the protection portions 41 and 42 will be described later.

The vibrator 8 is capable of vibrating in the left-right direction, and includes the mass body 6 and a magnet 7. That is, the vibration motor 10 includes the vibrator 8 capable of vibrating in the left-right direction.

The mass body 6 is made of a tungsten alloy, for example, and increases vibration output of the vibration motor 10 by increasing weight of the vibrator 8. The mass body 6 is formed in a rectangular body shape expanding in the left-right direction and the fore-and-aft direction and having a thickness in the up-down direction, and is provided with grooves 61 and 62 inward in the left-right direction. The grooves 61 and 62 extend throughout the mass body 6 in the fore-and-aft direction. The grooves 61 and 62 face each other in the up-down direction. The groove 61 is disposed above the groove 62. That is, the grooves 61 and 62 are provided in upper and lower surfaces of the mass body 6, respectively. The groove 61 is recessed downward. The groove 62 is recessed upward. That is, the vibrator 8 includes the mass body 6 having the grooves 61 and 62 recessed in the up-down direction.

The vibrator 8 also includes the magnet 7 fixed to the mass body 6 inside the grooves 61 and 62 when viewed in the up-down direction.

The magnet 7 has magnetic poles in the left-right direction. That is, the magnet 7 has an N pole on the left and an S pole on the right, or has the S pole on the left and the N pole on the right.

The mass body 6 has a through-hole 63 penetrating in the up-down direction. The through-hole 63 is adjacent below the groove 61 and above the groove 62. That is, the mass body 6 has the through-hole 63 that is adjacent to the grooves 61 and 62 in the up-down direction and penetrates in the up-down direction. The magnet 7 is fixed inside the through-hole 63 with an adhesive, for example. That is, the magnet 7 is provided in the through-hole 63. This structure enables the vibration motor 10 to be made thinner than that with the magnet provided inside the groove.

The coil 31 and the protection portion 41 are disposed inside the groove 61. The coil 32 and the protection portion 42 are disposed inside the groove 62. That is, the coils 31 and 32 are disposed in the grooves 61 and 62 on the upper and lower surfaces, respectively. This structure enables the vibration motor 10 to be further thinned. The upper and lower coils 31 and 32 enable acquiring electromagnetic force, so that vibration output increases.

The magnet 7 faces the coils 31 and 32 in the up-down direction. That is, the stator 5 includes the coils 31 and 32 that face the magnet 7 in the up-down direction and that are disposed inside the grooves 61 and 62, respectively.

The elastic portion 91 is provided on the left side of the vibrator 8. The elastic portion 92 is provided on the right side of the vibrator 8. That is, the vibration motor 10 includes two elastic portions. The elastic portions 91 and 92 are each formed in an S shape when viewed in the up-down direction.

The elastic portion 91 is fixed at its one end to a left end surface 6L of the mass body 6. The elastic portion 91 is fixed at its other end to an inner wall surface of the left surface part 114 of the lid 11. As a result, the elastic portion 91 connects the vibrator 8 and the housing 1. The elastic portion 92 is fixed at its one end to a right end surface 6R of the mass body 6. The elastic portion 92 is fixed at its other end to an inner wall surface of the right surface part 115 of the lid 11. As a result, the elastic portion 92 connects the vibrator 8 and the housing 1. That is, the vibration motor 10 includes the elastic portions 91 and 92 that connect the vibrator 8 and the stator 5. Details of the elastic portions 91 and 92 will be described later.

The vibration motor 10 configured as described above generates lines of magnetic force in the coils 31 and 32 by supplying an electric current to the coils 31 and 32 via the board 2, and thus enables the vibrator 8 to be driven in the left-right direction by interaction of the lines of magnetic force with lines of magnetic force generated by the magnet 7. Appropriate control of supply of an electric current to the coils 31 and 32 and elastic force of the elastic portions 91 and 92 generate oscillation in the left-right direction in the vibration motor 10.

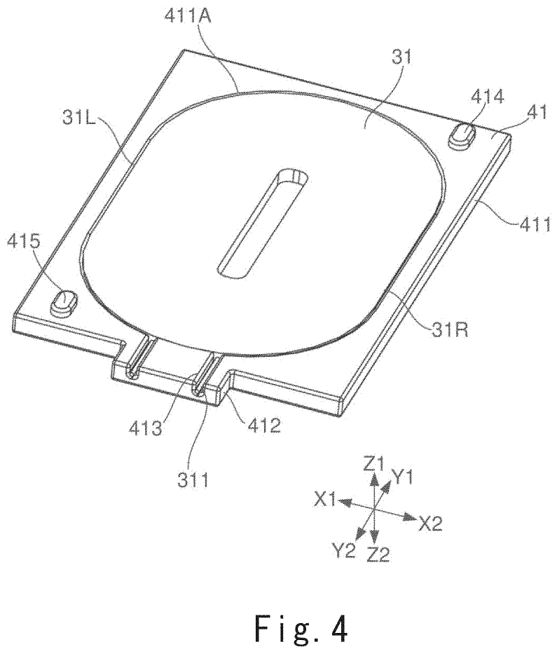

Next, the coils 31 and 32 and the protection portions 41 and 42 will be described in detail. FIG. 4 is a perspective view of an assembly including the coil 31 and the protection portion 41. The protection portion 41 is a plate-like member that expands in the left-right direction and the fore-and-aft direction and has a thickness in the up-down direction, and includes a base 411 and a protruding piece 412. The base 411 has a rectangular shape. The protruding piece 412 protrudes forward from a front edge of the base 411. The base 411 is provided with a hole 411A penetrating in the up-down direction. The coil 31 is accommodated in the hole 411A and fixed to the base 411 with an adhesive, for example. As a result, an assembly including the coil 31 and the protection portion 41 is created, and the assembly is attached to the lower surface of the top surface part 111 of the housing 1. The coil 31 is fixed to the protection portion 41 as described above. This structure allows the assembly of the coil 31 and the protection portion 41 to be first created, and then enables the stator 5 to be formed by fixing the assembly to the housing 1. This structure thus facilitates manufacturing of the stator 5.

The base 411 is provided with protrusions 414 and 415 protruding upward. The protrusions 414 and 415 are disposed on a diagonal line of the base 411 when viewed in the up-down direction. When the assembly is attached to the top surface part 111, the protrusions 414 and 415 are respectively fitted into recesses 111A and 111B (see FIG. 1) provided in the top surface part 111. This facilitates positioning of the assembly. The protection portion 41 may be provided with a recess, and the top surface part 111 may be provided with a protrusion.

That is, one of the housing 1 and the protection portion 41 has the recesses 111A and 111B, and the other has the protrusions 414 and 415 that are to be fitted into the recesses 111A and 111B, respectively. This facilitates positioning of the protection portion 41. Due to the mass body 6 that can come into contact with the protection portion 41 as described later, the protection portion 41 can be more firmly fixed.

The recesses 111A and 111B, and the protrusions 414 and 415, are disposed at respective diagonal positions in the protection portion 41 when viewed in the up-down direction. That is, the recesses 111A and 111B, and the protrusions 414 and 415, are at least disposed across the coil 31 when viewed in the up-down direction. This structure prevents the protection portion 41 from rotating around the protrusion when the vibrator 8 comes into contact with the protection portion 41, so that the protection portion 41 can be more firmly fixed.

As illustrated in FIG. 4, the entire circumference of the coil 31 is covered with the protection portion 41 while the coil 31 is fixed to the protection portion 41. This structure allows the coil 31 to have a left end 31L and a right end 31R that are each covered with the protection portion 41 throughout in the fore-and-aft direction. Thus, one protection portion 41 covering the entire circumference of the coil 31 can prevent the vibrator 8 from coming into contact with the coil 31 from both the left and right sides. The protection portion 41 may be divided into left and right parts that are configured to partly cover the left end 31L and the right end 31R of the coil 31, respectively.

In other words, the stator 5 includes the protection portion 41 configured to cover at least partly both the ends 31L and 31R of the coil 31 in the left-right direction.

As illustrated in FIG. 4, the protruding piece 412 is provided with two guides 413 formed as grooves extending in the fore-and-aft direction. When the coil 31 is fixed to the base 411, a lead wire 311 of the coil 31 is passed through each guide 413. Here, the front surface part 112 of the lid 11 is provided with a drawer port 112A opened in the fore-and-aft direction (see FIG. 1). When the assembly is fixed to the top surface part 111, the lead wire 311 of the coil 31 is drawn out from the drawer port 112A to the outside. At this time, the lead wire 311 is fixed to the guide 413 and the guide 413 extends to near the drawer port 112A, so that drawing is facilitated. The lead wire 311 drawn from the drawer port 112A is connected to corresponding one of electrode parts 21A and 22A (FIG. 2) provided in the bent portions 21 and 22 of the board 2, respectively. FIGS. 1, 2, and 4 each do not illustrate a part of the lead wire 311 drawn out from the guide 413.

As described above, the coil 31 includes the lead wire 311. The protection portion 41 includes the guide 413 that guides the lead wire 311. This structure enables the lead wire 311 to be protected by the protection portion 41. When the coil 31 is fixed to the protection portion 41, the lead wire 311 is passed through the guide 413, and thus further facilitating routing work.

The coil 31 may be fixed to the protection portion 41 by manufacturing the coil 31 and the protection portion 41 by integral molding. This structure enables suppressing an adverse effect on winding caused by a worker touching the coil 31 even using the coil 31 having a wire diameter reduced to improve a space factor of the winding.

The protection portion 42 is identical in shape to the protection portion 41. The coil 32 is fixed to the protection portion 42 to create an assembly, and the assembly is fixed to the upper surface of the base plate 12. At this time, the protection portion 42 is fixed while being vertically inverted from the protection portion 41. The protection portion 42 is provided with a protrusion (not illustrated) protruding downward that is to be fitted into a recess (not illustrated) provided in the base plate 12. The protrusion and the recess are disposed on a diagonal line intersecting a diagonal line on which the protrusions 414 and 415, and the recesses 111A and 111B, are disposed when viewed in the up-down direction. The lead wire 321 of the coil 32 is guided by a guide 423 of the protection portion 42 (see FIG. 1). The lead wire 321 is drawn to the outside from a drawer port 112B provided in the front surface part 112 of the lid 11, and is connected to the corresponding one of the electrode parts 21A and 22A provided in the bent portions 21 and 22 of the board 2, respectively. The electrode part 21A is connected to an electrode part 20A (FIG. 2) provided on the base 20 with wiring (not illustrated) provided on the board 2. The electrode part 22A is connected to an electrode part 20B (FIG. 2) provided on the base 20 with wiring (not illustrated) provided on the board 2. An electric current for driving the coils 31 and 32 flows through in order from the electrode part 20A (or 20B), the electrode part 21A (or 22A), the coil 31 or 32, the electrode part 22A (or 21A), to the electrode part 20B (or 20A).

As described above, the protection portions 41 and 42 provided up and down are identical in shape. As a result, the protection portions 41 and 42 identical in shape can be used above and below, so that the number of molds for molding the protection portion can be reduced. When the protection portions 41 and 42 are assembled, the protection portions may be disposed upside down.

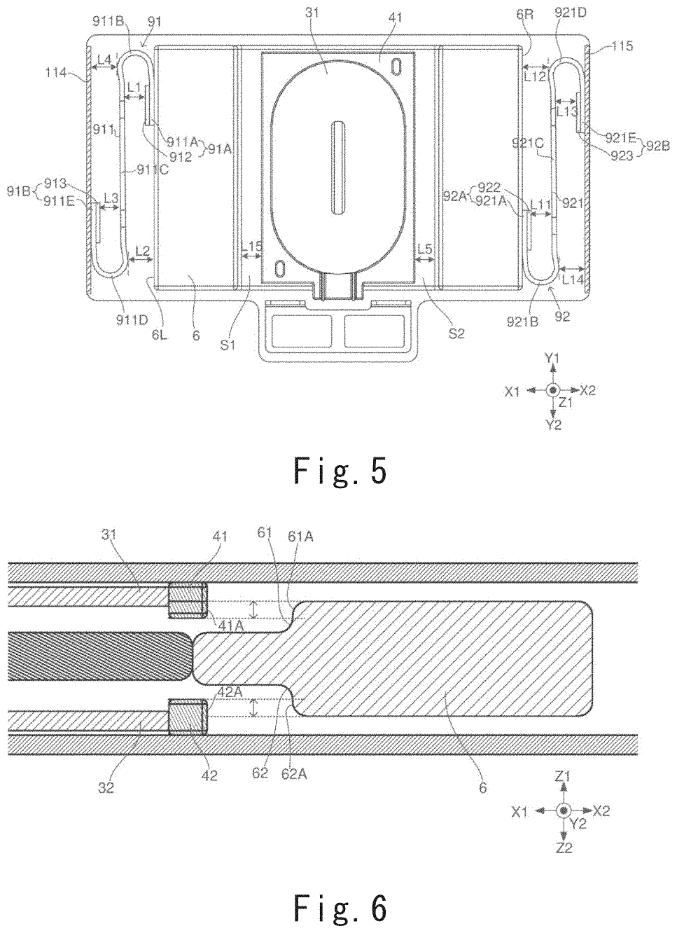

Next, details of the elastic portions 91 and 92 will be described. FIG. 5 is a plan view illustrating an internal configuration of the vibration motor 10 as viewed from above. FIG. 5 illustrates only a part of the lid 11.

As illustrated in FIG. 5, the elastic portion 91 includes a leaf spring 911 and reinforcing plates 912 and 913. The leaf spring 911 includes a first end part 911A, a first bent portion 911B, a flat plate portion 911C, a second bent portion 911D, and a second end part 911E, and is formed in an S shape when viewed in the up-down direction.

The first end part 911A is fixed to a front side of the left end surface 6L of the mass body 6 by welding, for example. The reinforcing plate 912 is fixed to the first end part 911A by welding, for example. The first end part 911A and the reinforcing plate 912 constitute a first fixing portion 91A.

The first bent portion 911B is connected at its one end part to a front end part of the first end part 911A. The first bent portion 911B is bent in the fore-and-aft direction. The flat plate portion 911C extending in the fore-and-aft direction is connected at its one end part to the other end part of the first bent portion 911B. The second bent portion 911D is connected at its one end part to the other end part of the flat plate portion 911C. The second bent portion 911D is bent in the fore-and-aft direction. The second end part 911E is connected to the other end part of the second bent portion 911D.

The second end part 911E is fixed to the inner wall surface of the left surface part 114 of the lid 11 by welding, for example. The reinforcing plate 913 is fixed to the second end part 911E by welding, for example. The second end part 911E and the reinforcing plate 913 constitute a second fixing portion 91B.

In other words, the elastic portion 91 includes the first fixing portion 91A fixed to an end surface of the vibrator 8 in the left-right direction, the first bent portion 911B connected to the first fixing portion 91A, the flat plate portion 911C connected to the first bent portion 911B, the second bent portion 911D connected to the flat plate portion 911C, and the second fixing portion 91B connected to the second bent portion 911D and fixed to the stator 5. This structure caused the first bent portion 911B and the second bent portion 911D to be elastically deformed when the vibration motor 10 is driven. The elastic portion 91 has two deformation places and stress is dispersed into each of the places, so that a life span of the elastic portion 91 increases.

The first bent portion 911B and the second bent portion 911D are identical in shape. As a result, stress is equally dispersed into the first bent portion 911B and the second bent portion 911D, so that the life span of the elastic portion 91 further increases.

Although detailed description of the elastic portion 92 is eliminated due to its configuration similar to that of the elastic portion 91, the elastic portion 92 includes a leaf spring 921, and reinforcing plates 922 and 923. A first end part 921A of the leaf spring 921 and the reinforcing plate 922 constitute a first fixing portion 92A. The first fixing portion 92A is fixed to a rear side of the right end surface 6R of the mass body 6. A second end part 921E of the leaf spring 921 and the reinforcing plate 923 constitute a second fixing portion 92B. The second fixing portion 92B is fixed to the inner wall surface of the right surface part 115 of the lid 11. The elastic portion 92 as described above also has an effect similar to that of the elastic portion 91.

Next, a function of protecting the coils 31 and 32 will be described. FIG. 6 is a partial sectional view of the vibration motor 10 taken along a section orthogonal to the fore-and-aft direction. FIG. 6 illustrates a partial structure of the vibration motor 10 on a right side.

The groove 61 disposed above is provided with a first opposing surface 61A. The protection portion 41 disposed above is provided at its right end surface with a second opposing surface 41A. The first opposing surface 61A and the second opposing surface 41A face each other in the left-right direction. FIG. 6 illustrates an arrow that indicates a range in which the first opposing surface 61A and the second opposing surface 41A are formed.

The groove 62 disposed below is provided with a first opposing surface 62A. The protection portion 42 disposed below is provided at its right end surface with a second opposing surface 42A. The first opposing surface 62A and the second opposing surface 42A face each other in the left-right direction. FIG. 6 illustrates an arrow that indicates a range in which the first opposing surface 62A and the second opposing surface 42A are formed.

This kind of configuration allows the first opposing surfaces 61A and 62A of the mass body 6 to come into contact with the second opposing surfaces 41A and 42A of the protection portions 41 and 42, respectively, even when the mass body 6 excessively moves to the left when the vibration motor 10 is dropped, for example, and thus prevents the mass body 6 from coming into contact with the coils 31 and 32 to enable protecting the coils 31 and 32.

Here, when the elastic portion has a V-shape as viewed in the up-down direction as in a conventional case, for example, a cushioning member is provided in the elastic portion to suppress movement of a vibrator by bringing parts of the elastic portion into contact with each other with the cushioning member interposed therebetween before the vibrator comes into contact with a coil, and thus the coil can be protected. Unfortunately, the conventional elastic portion described above has one place to be bent, so that stress concentration is a problem. In contrast, the present example embodiment causes the elastic portion 91 to be formed in an S shape when viewed in the up-down direction. However, the present example embodiment has an undesirable case in which cushioning members are provided in the first fixing portion 91A and the second fixing portion 91B, for example, to cause not only the first fixing portion 91A and the flat plate portion 911C, but also the second fixing portion 91B and the flat plate portion 911C, to be in contact with each other with the cushioning members interposed therebetween. That is, even indirect contact between parts of the elastic portion 91 is undesirable for the elastic portion 91.

Thus, the present example embodiment causes the first opposing surfaces 61A and 62A to come into contact with the second opposing surfaces 41A and 42A, respectively, before the parts of the elastic portion 91 come into contact with each other, and thus protecting the coils 31 and 32.

FIG. 6 does not illustrate a partial structure of the vibration motor 10 on a left side, in which similarly the grooves 61 and 62 are each provided with a first opposing surface, and the protection portions 41 and 42 are each provided at its left end surface with a second opposing surface. Thus, even when the mass body 6 moves excessively rightward, the coils 31 and 32 are protected by the first opposing surfaces coming into contact with the respective second opposing surfaces. At this time, the first opposing surfaces come into contact with the respective second opposing surfaces before parts of the elastic portion 92 come into contact with each other.

As described above, the grooves 61 and 62 in the present example embodiment are provided with the first opposing surfaces 61A and 62A, respectively. The protection portions 41 and 42 are provided with the second opposing surfaces 41A and 42A, respectively. The first opposing surfaces 61A and 62A, and the second opposing surfaces 41A and 42A, respectively face each other in the left-right direction. This structure enables protecting the coils 31 and 32 without bringing parts of the respective elastic portions 91 and 92 into contact with each other.

More specific configurations are described below to prevent parts of the respective elastic portions 91 and 92 from coming into contact with each other. As illustrated in FIG. 5, the elastic portion 91 in a state where the vibrator 8 is stationary has distances including a left-right distance L1 between the first fixing portion 91A and the flat plate portion 911C, a left-right distance L2 between the second bent portion 911D and the left end surface 6L, a left-right distance L3 between the flat plate portion 911C and the second fixing portion 91B, and a left-right distance L4 between the first bent portion 911B and the left surface part 114, all the distances being set larger than half of a left-right distance L5 of a right gap S2 of gaps S1 and S2 formed between the groove 61 and the protection portion 41. When the mass body 6 moves leftward, the left-right distances L1 to L4 are shortened by half a length by which the left-right distance L5 is shortened. Thus, setting conditions of the distances as described above prevents contact between the first fixing portion 91A and the flat plate portion 911 C, contact between the left end surface 6L and the second bent portion 911D, contact between the second fixing portion 91B and the flat plate portion 911C, and contact between the first bent portion 911B and the left surface part 114 when the mass body 6 comes into contact with the protection portion 41.

In contrast, the elastic portion 92 in a state where the vibrator 8 is stationary has distances including a left-right distance L11 between the first fixing portion 92A and the flat plate portion 921C, a left-right distance L12 between the second bent portion 921D and the right end surface 6R, a left-right distance L13 between the flat plate portion 921C and the second fixing portion 92B, and a left-right distance L14 between the first bent portion 921B and the right surface part 115, all the distances being set larger than half of a left-right distance L15 of the left gap S1 of the gaps S1 and S2 formed between the groove 61 and the protection portion 41. When the mass body 6 moves rightward, the left-right distances L11 to L14 are shortened by half a length by which the left-right distance L15 is shortened. Thus, setting conditions of the distances as described above prevents contact between the first fixing portion 92A and the flat plate portion 921 C, contact between the right end surface 6R and the second bent portion 921D, contact between the second fixing portion 92B and the flat plate portion 921C, and contact between the first bent portion 921B and the right surface part 115 when the mass body 6 comes into contact with the protection portion 41.

In other word, the distances in a state where the vibrator 8 is stationary include the left-right distances L1 and L11 between the first fixing portions 91A and 92A, and the corresponding flat plate portions 911C and 921C, the left-right distances L2 and L12 between the second bent portions 911D and 921D, and the corresponding left and right end surfaces 6L and 6R, the left-right distances L3 and L13 between the flat plate portions 911C and 921C, and the corresponding second fixing portions 91B and 92B, and the left-right distances L4 and L14 between the first bent portions 911B and 921B, and the stator 5, all the distances being larger than half of the corresponding left-right distances L5 and L15 between the groove 61 and the protection portion 41. This configuration enables preventing the contact between parts of the respective elastic portions 91 and 92, the contact between the elastic portions 91 and 92 and the mass body 6, and the contact between the elastic portions 91 and 92 and the stator 5 when the mass body 6 comes into contact with the protection portion 41.

Even when an elastic portion other than that in the present example embodiment is used, appropriate design of the left-right distances L5 and L15 between the groove 61 and the protection portion 41 enables a range of tension and compression of the elastic portion to be restricted to those corresponding to a desired distance.

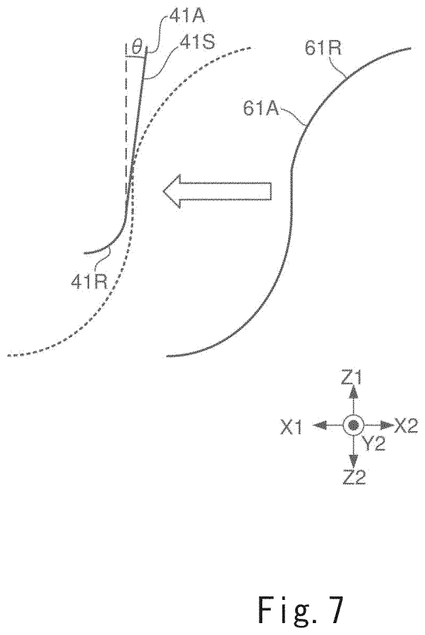

FIG. 7 is an enlarged view of the first opposing surface 61A and the second opposing surface 41A in the configuration illustrated in FIG. 6. As illustrated in FIG. 7, the second opposing surface 41A has a tapered surface 41S that extends toward the coil 31 while extending downward or toward the mass body 6. The tapered surface 41S is inclined by an inclination angle θ with respect to the up-down direction. The inclination angle θ is 5 degrees, for example. The second opposing surface 41A has a corner 41R connected to a lower side of the tapered surface 41S.

This structure causes the first opposing surface 61A to come into contact with the tapered surface 41S even when the mass body 6, or the first opposing surface 61A moves leftward as indicated by an arrow in FIG. 7 and comes into contact with the second opposing surface 41A, and thus enables the mass body 6 to be prevented from being displaced upward in a Z1 direction. Additionally, the corner 41R is formed as a rounded part, so that the corner 41R is prevented from coming into contact with the first opposing surface 61A. The first opposing surface 61A also has a corner 61R formed as a rounded part, so that the corner 61R is prevented from coming into contact with the second opposing surface 41A.

The first opposing surface 62A and the second opposing surface 42A are also configured similarly to the first opposing surface 61A and the second opposing surface 41A. This configuration enables preventing the mass body 6 from being displaced downward in a Z2 direction.

That is, the second opposing surfaces 41A and 42A desirably include tapered surfaces extending toward the coils 31 and 32, respectively, while extending toward the mass body 6. This structure enables the mass body 6 to be prevented from being displaced in the up-down direction, thereby enabling the mass body 6 to be prevented from coming into contact with the housing 1.

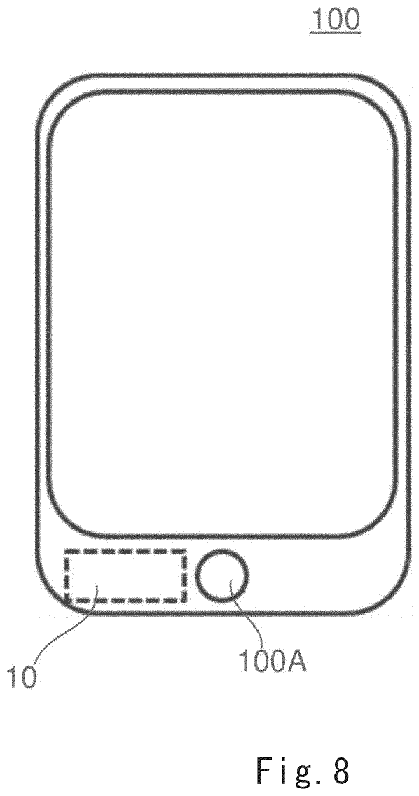

The vibration motor 10 according to the example embodiment described above can be mounted on an electronic device 100 schematically illustrated in FIG. 8, for example. That is, the electronic device 100 includes the vibration motor 10. The electronic device 100 gives tactile stimulation to a person who operates the electronic device 100 by vibration of the vibration motor 10. Although the electronic device 100 illustrated in FIG. 8 is a smartphone as an example, a tablet, a game device, a wearable terminal, and the like are available.

The electronic device 100 as illustrated in FIG. 8 allows the vibration motor 10 to output vibration, so that not only various notifications such as an incoming call but also tactile feedback can be given to an operator. Examples of the tactile feedback include a feeling as if to press a button, the feeling being able to be obtained by an operator due to vibration output by the vibration motor 10 when the operator presses a recess 100A illustrated in FIG. 8. In particular, using the vibration motor 10 according to the example embodiment described above enables protecting the coils 31 and 32, and thus enables preventing a failure of vibration of the electronic device 100 due to a failure of the coils 31 and 32.

The example embodiment of the present disclosure has been described above. The above example embodiment does not limit the scope of the present disclosure. The present disclosure can be implemented by making various changes to the above example embodiment without departing from the gist of the disclosure. The above example embodiment describes matters that can be optionally combined together, as appropriate, as long as there is no inconsistency.

The technique of the present disclosure can be used for a vibration motor mounted on various devices, for example.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vibration motor comprising:
a stator;
a vibrator capable of vibrating in a left-right direction; and
an elastic portion that connects the vibrator and the stator; wherein
the vibrator includes:
a mass body including a groove recessed in an up-down direction; and
a magnet fixed to the mass body inside the groove when viewed in the up-down direction;
the stator includes:
a coil located inside the groove and opposing the magnet in the up-down direction; and
a protector covering at least a portion of two ends of the coil in the left-right direction;
the groove includes a first opposing surface;
the protector includes a second opposing surface; and
the first opposing surface and the second opposing surface oppose each other in the left-right direction.

2. The vibration motor according to claim 1, wherein the protector covers an entire circumference of the coil.

3. The vibration motor according to claim 1, wherein
the stator further includes a housing that covers the vibrator, the elastic portion, the coil, and the protector; and
one of the housing and the protector includes a recess, and another includes a protrusion fitted into the recess.

4. The vibration motor according to claim 3, wherein the recess and the protrusion are located at least across the coil when viewed in the up-down direction.

5. The vibration motor according to claim 1, wherein the coil is fixed to the protector.

6. The vibration motor according to claim 1, wherein
the coil includes a lead wire; and
the protector includes a guide to guide the lead wire.

7. The vibration motor according to claim 1, wherein the elastic portion includes:
a first fixing portion fixed to an end surface of the vibrator in the left-right direction;
a first bent portion connected to the first fixing portion;
a flat plate portion connected to the first bent portion;
a second bent portion connected to the flat plate portion; and
a second fixing portion connected to the second bent portion and fixed to the stator.

8. The vibration motor according to claim 7, wherein the first bent portion and the second bent portion are identical in shape.

9. The vibration motor according to claim 7, wherein
distances in a state where the vibrator is stationary include a left-right distance between the first fixing portion and the flat plate portion, a left-right distance between the second bent portion and the end surface in the left-right direction, a left-right distance between the flat plate portion and the second fixing portion, and a left-right distance between the first bent portion and the stator; and
all the distances are larger than half of a left-right distance between the groove and the protector.

10. The vibration motor according to claim 1, wherein
the mass body includes a through hole adjacent to the groove in the up-down direction and penetrating in the up-down direction; and
the magnet is provided in the through hole.

11. The vibration motor according to claim 1, wherein the second opposing surface includes a tapered surface extending toward the coil while extending toward the mass body.

12. The vibration motor according to claim 1, wherein
the groove is provided in each of upper and lower surfaces of the mass body; and
the coil is located in the groove in each of the upper and lower surfaces.

13. The vibration motor according to claim 12, wherein the protectors provided up and down are identical in shape.

14. An electronic device comprising the vibration motor according to claim 1.
